(19) United States
(12) Patent Application Publication
(10) Pub. No.: US 2007/0094784 A1
(43) Pub. Date: May 3, 2007

(54) SPA AIR SYSTEM

(76) Inventor: Trong Tran, Huntington Beach, CA (US)

Correspondence Address: LAW OFFICES OF LARRY K. ROBERTS, INC., 2 Park Plaza, Suite 300, Irvine, CA, 92614, US

(21) Appl. No.: 11/470,366

(22) Filed: Sep. 6, 2006

Related U.S. Application Data
(60) Provisional application No. 60/715,323, filed on Sep. 7, 2005.

(51) Int. Cl. A61H 33/06

(52) U.S. Cl. 4/541.5

(57) ABSTRACT

A spa system comprises a water jet having a water flow path and an air injection port in communication with the water flow path. An air system is fluidically connected to the air injection port. The air system comprises an air inlet port and an air inlet valve. An electronic controller is arranged to control actuation of the air inlet valve.

### CROSS-REFERENCE TO RELATED APPLICATION

This application claims the benefit of U.S. Provisional Application No. 60/715,323 filed Sep. 7, 2005, hereby incorporated by reference.

### BACKGROUND OF THE DISCLOSURE

A bathing system such as a spa typically includes a vessel for holding water, pumps, a blower, water jets, a light, a heater and a control for managing these features. A bathing system may include an air system which permits air to be entrained within a water stream to be jetted into the vessel. The control may include a control panel and a series of switches which connect to the various components with electrical wire.

### BRIEF DESCRIPTION OF THE DRAWINGS

Features and advantages of the disclosure will be readily appreciated by persons skilled in the art from the following detailed description of exemplary embodiments thereof, as illustrated in the accompanying drawings, in which:

FIG. 1 is a schematic diagram of a system for bathers including a vessel for holding bathing water, a control system, and associated water management equipment.

FIG. 2 illustrates an exemplary air system for a spa.

FIG. 3 illustrates an exemplary air system for a spa.

FIG. 4 illustrates an exemplary embodiment of a method of operating a spa system.

FIGS. 5A-5D illustrate exemplary operational sequences for a spa air system.

FIG. 6 illustrates an exemplary embodiment of a spa system.

### DETAILED DESCRIPTION OF THE DISCLOSURE

In the following detailed description and in the several figures of the drawing, like elements are identified with like reference numerals.

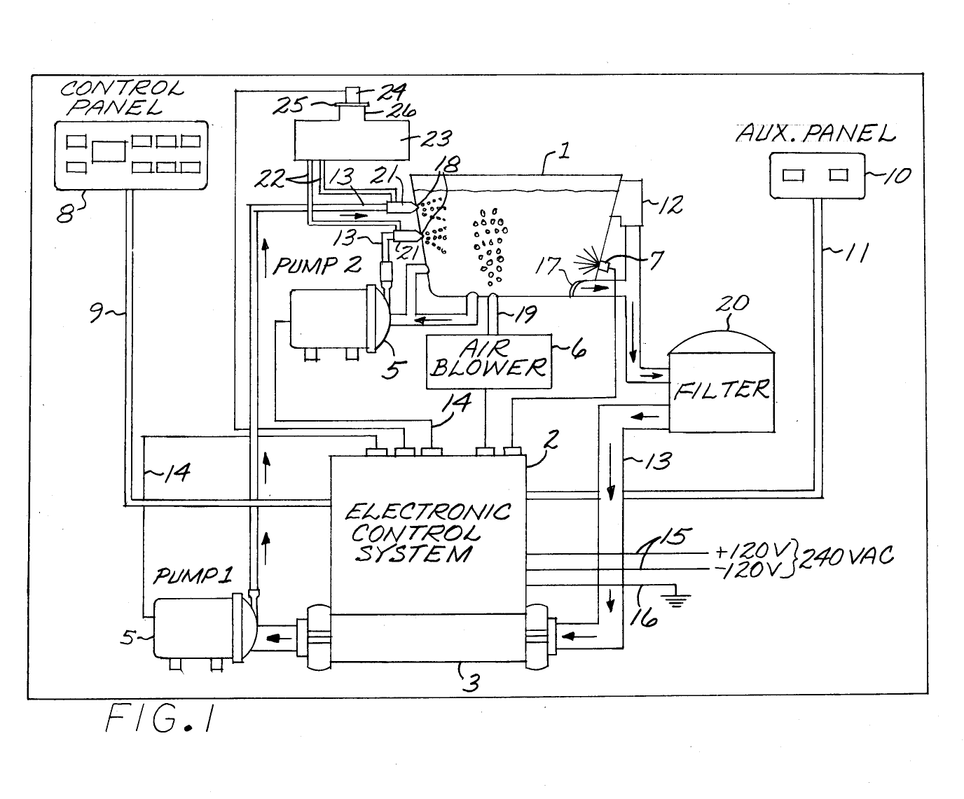

FIG. 1 illustrates an overall block diagram of an exemplary embodiment of a spa system. The system includes a vessel 1 for holding a volume of water, and a control system 2 to activate and manage the various parameters of the spa. Connected to the vessel 1 through a series of plumbing lines 13 are pumps 4 and 5 for pumping water, a skimmer 12 for cleaning the surface of the vessel, a filter 20 for removing particulate impurities in the water, an air blower 6 for delivering bubbles to the vessel through air pipe 19, and an electric heater 3 for maintaining the temperature of the spa at a temperature set by the user. Generally, a light 7 is provided for internal illumination of the water.

In an exemplary embodiment, service voltage power is supplied to the spa control system by electrical service wiring 15, which can be 120V or 240V single phase 60 cycle, 220V single phase 50 cycle, or any other generally accepted power service suitable for commercial or residential service. An earth ground 16 is connected to the control system and there through to all electrical components which carry service voltage power and all metal parts. Electrically connected to the control system through respective cables 9 and 11 are the control panels 8 and 10. All components powered by the control system are connected by cables 14 suitable for carrying appropriate levels of voltage and current to properly operate the spa. Water is drawn to the plumbing system generally through the skimmer 12 or suction fittings 17, and discharged back into the vessel through jets 18.

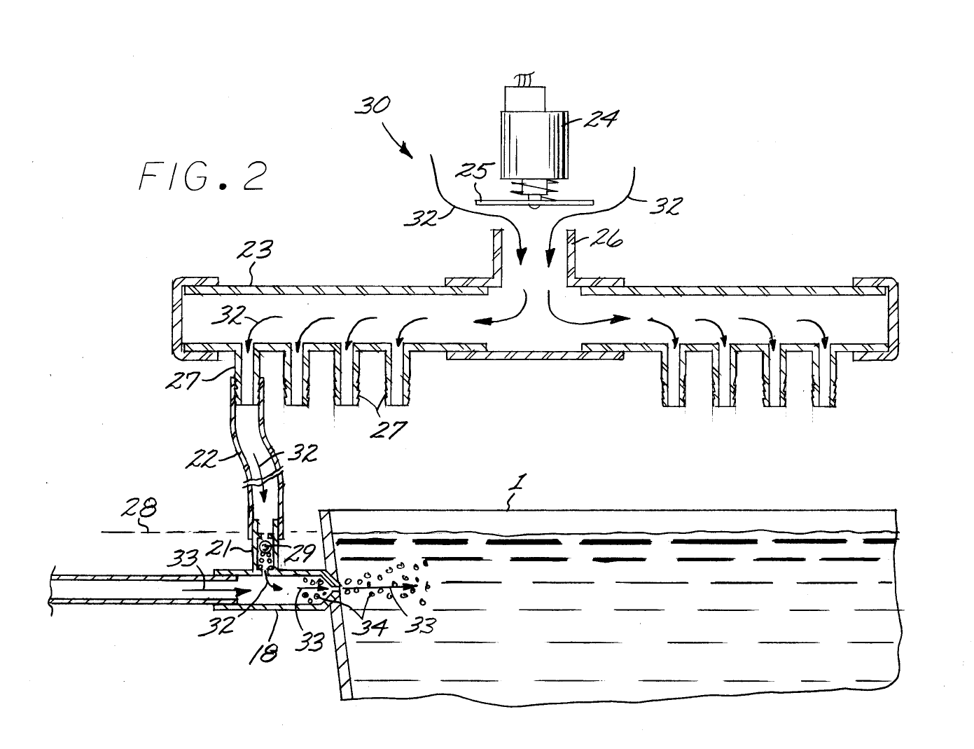

In an exemplary embodiment, the jets 18 have air injection ports or fittings 21, connected to air hoses 22 which, in turn, are connected to an air manifold 23. The air injection ports 21 may be in communication with the water side of the jets 18. The operation of the jets 18 draw air into the water stream 33 (FIG. 2) being jetted into the vessel 1, so that a user positioned in the vessel and in front of a jet 18 may experience a sensation or physical effects caused by the combination of water and air bubbles being jetted against a portion of the user's body.

In an exemplary embodiment, the air manifold 23 may be a common source of air for more than one therapy jet. In other embodiments, more than one air manifold 23, each with its own air inlet valve 24 or valves, may provide separate sources of air to different sets of jets 18. The air manifold 23 may be mounted above the water level 28 (FIG. 2), which may prevent the air injection system from flooding with water.

In an exemplary embodiment, an air inlet valve 24 may be opened or closed to lift a valve plate 25 from an air system air inlet port 26. When the air inlet valve 24 is open, air may be drawn into the manifold. When the air inlet valve 24 is closed, air may be prevented from being drawn into the manifold.

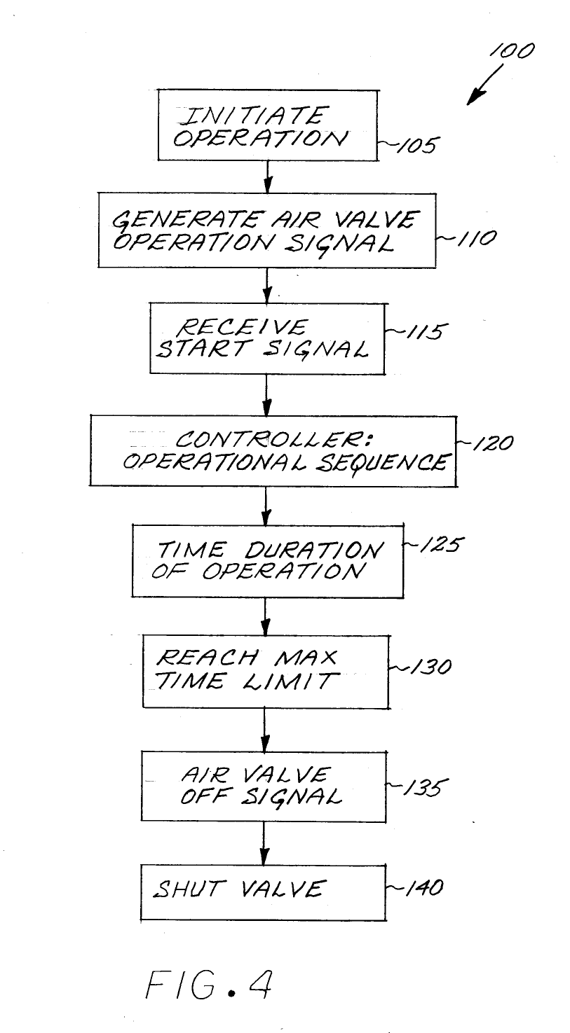

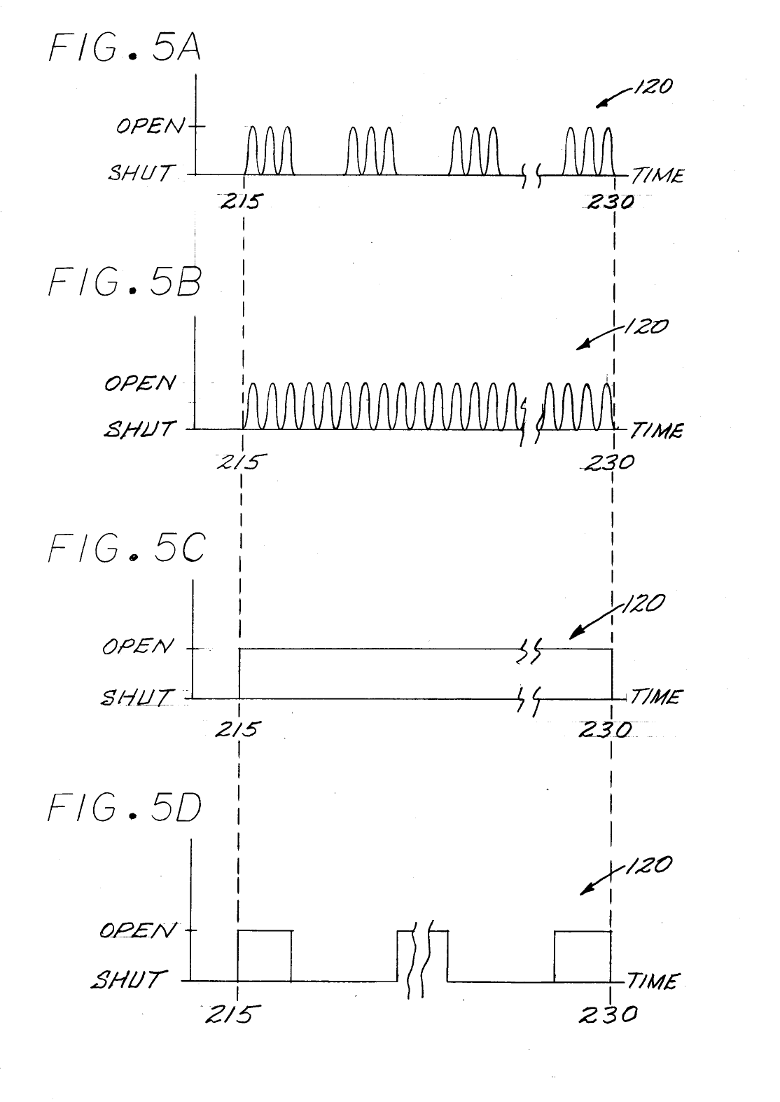

In an exemplary embodiment, the air inlet valve 24 may be an electronically controlled valve, including for example a solenoid valve actuator. In an exemplary embodiment, the current or power provided to operate the air inlet valve is controlled by or through the control system 2. Operation of the air inlet valve may also be controlled by a user at the control panels 8 and/or 10. Various operational sequences may be pre-programmed into the electronic control system, and a user may select among the various pre-programmed operational sequences at the control panel 8, 10, as described below with respect to FIGS. 4 and 5A-5D. The electronic control system may also be arranged or programmed to limit the duration of operation of the air inlet valve 24 as described with respect to FIGS. 4 and 5A-5D.

FIG. 2 illustrates an exemplary embodiment of an air injection system 30 for a spa 1. In this exemplary embodiment, the air injection system 30 provides air 32 which forms air bubbles 34 in a water stream 33 being injected into a vessel 1. A user positioned in the vessel 1 and in front of a jet 18 may experience or feel the sensation or physical effects caused by the combination of the water stream 33 and air bubbles 34 which are jetted into the vessel 1 under pressure created by a pump 5 (FIG. 1) or pumps. The sensation or physical effects caused by the water stream 33 and air bubbles 34 may be a massage.

In an exemplary embodiment, the air injection system 30 comprises an air manifold 23. The air manifold 23 may be a cylindrical tube and may be constructed from PVC piping. The air injection system 30 may have at least one air inlet valve 24 and at least one air outlet port 27. In an exemplary embodiment, an air manifold 23 may have a plurality of air outlet ports 27 which provide air to a plurality of jets 18. In an exemplary embodiment, a spa may have a plurality of air manifolds, each providing air to different groups of jets.

In an exemplary embodiment, the air inlet valve 24 may be a solenoid operated valve. The air inlet valve 24 may be spring-biased to be normally closed and may open upon receipt of an electrical signal. The air inlet valve may have a valve plate 25 which may cover an air system air inlet port 26 when in the closed position. In an exemplary embodiment, the air inlet valve 24 may be opened when an electrical current is applied to it. The electrical signal may cause the valve to retract and lift the valve plate 25 from the air inlet port 26.

In an exemplary embodiment, the spa air injection system 30 may comprise at least one water jet 18. The fluid dynamics, for example the venturi effect of the water stream 33 flowing through the jet 18, create a region of low pressure, or vacuum, within the jet 18. At this region of low pressure or vacuum, the water jet 18 may have an air injection port 21 which is connected to the manifold 23, for example through tubes 22. Since the air outside of the air system air inlet port 26 may be at ambient air pressure, for example atmospheric air pressure, if the air inlet valve 24 is open while the water stream 33 is flowing through the jet 18, a pressure gradient will develop between the ambient air pressure outside the manifold and the vacuum generated at the jet 18. The air pressure gradient may tend to draw air 32 into the air inlet port 26, through the manifold 23, the tubes 22 and into the jet, where it creates air bubbles 34 which are jetted into the vessel along with the water stream 33.

In an exemplary embodiment, the jet 18 may have a check-valve 29, for example a ball check valve, which may be spring-biased to be closed when no vacuum (or insufficient vacuum) is present to cause the valve to open against the spring force. A lack of vacuum or low vacuum may occur, for example, when no or insufficient water flow is present. No water flow may be present, for example, when a water pump shuts off, when the water line is plugged, or when the water/air jet inlet into the spa is stopped up, for example when a user leans against the jet during use. In an exemplary embodiment, the check valve 29 may prevent water from backing up into the air system.

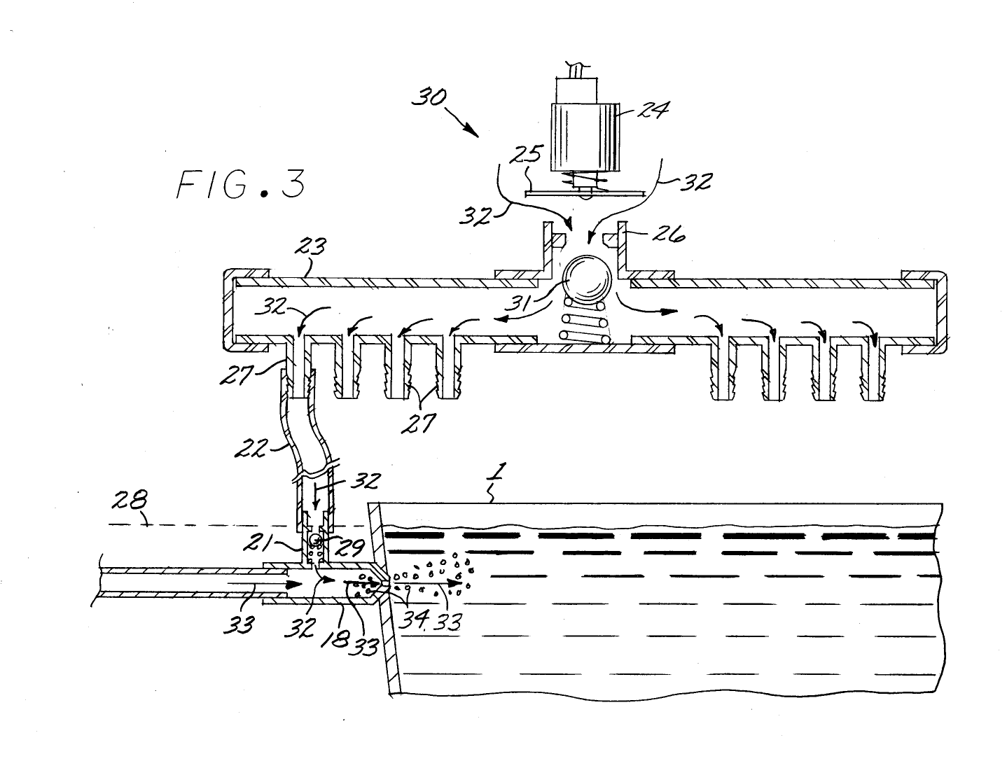

FIG. 3 illustrates an exemplary embodiment of an air system 30 for a spa. The air system 30 includes an air system air inlet port 26 and air inlet valve 24. In an exemplary embodiment, a check valve 31 may be arranged within the air inlet port 26. The check valve 31 may be spring biased to be closed in the absence of a vacuum.

In an exemplary embodiment, a spa controller may be programmed to open or shut the air inlet valve 24 in response to certain other conditions. For example, FIG. 4 illustrates an exemplary flow chart for an exemplary, pre-programmed operating instruction 100 for the air injection system 30 (FIG. 2).

In an exemplary embodiment, the controller 2 (FIG. 1) is pre-programmed to shut the air inlet valve, or stop an operational sequence 120, after a pre-determined maximum operational period of time has elapsed. For example, the controller may be programmed to shut the air inlet valve after 15 minutes or 30 minutes—or some other maximum period of time. A user may manually initiate operation (105) of the air valve by operating a button or other control feature mounted on the spa, or on a control panel 8, 10 (FIG. 1) to generate an air valve operation signal (110). In response, the valve receives a signal or series of signals (115) to open and close according to an air inlet valve operational sequence (120). The controller may then time the operation of the air valve (125), starting from the receipt of the air valve operation signal. When the elapsed time exceeds a pre-programmed maximum air inlet valve operational time (130), the controller generates an air valve off signal (135). The air valve shuts off (140), upon receipt of the air valve off signal.

In an exemplary embodiment, programming the controller to prevent the air inlet valve from remaining open indefinitely may improve the efficiency of the spa system. For example, when the air valve is open, the water/air mix injected into the spa through the water jet includes both the water—which may be warmed to a temperature above ambient air temperature—and air, which may be drawn from ambient air which may be at an ambient air temperature which is lower than the spa water. If the valve were to remain open indefinitely, the heater on the spa may use more energy to maintain the temperature of the water at the desired temperature due to the continuing injection of lower-temperature air. If the spa is unoccupied while the valve is left open, the benefits to the user of having the air bubbles injected into the spa may not offset the increased operating costs of heating the air-cooled water. By shutting the air inlet valve after a pre-determined amount of time, the spa system prevents the valve from remaining open indefinitely after use. This may save energy where it reduces the load on the system heater.

In an exemplary embodiment, the controller may be pre-programmed with various, different air inlet valve operational sequences 120, for example massage sequences, as shown in FIGS. 5A-5D. FIGS. 5A-5D illustrate the open/shut state of the air inlet valve with respect to time. The air inlet valve is shut until the air inlet valve receives the start signal at some initial time 215 when the air valve receives the operational signal (115, FIG. 4). The air inlet valve then operates according to the selected, pre-programmed operational sequence 120 until the air inlet valve maximum operational time limit has been reached at some later time 230, which corresponds to the air valve off signal 135 (FIG. 4). The various operational sequences may include, for example, pulsed open/shut as shown in FIG. 5A, continuously on/off as shown in FIG. 5B, always open as illustrated in FIG. 5C or open/shut for longer periods as illustrated in FIG. 5D. In an exemplary embodiment, a user may select any of a number of available pre-programmed operational sequences.

In an exemplary embodiment, the various operational sequences may comprise, for example, massage sequences. The operational sequence may cause the air system to provide sequences of air bubbles which provide a specific sequence of massing bubbles available to a user. The combined effect of the water stream 33 and the entrained air bubbles 34 (FIG. 2) provide a user positioned in the spa in front of a water jet with a sensation, physical effect or massage which changes over time in a pre-programmed manner in accordance to a pre-programmed sequence, for example the sequences illustrated in FIGS. 5A-5D.

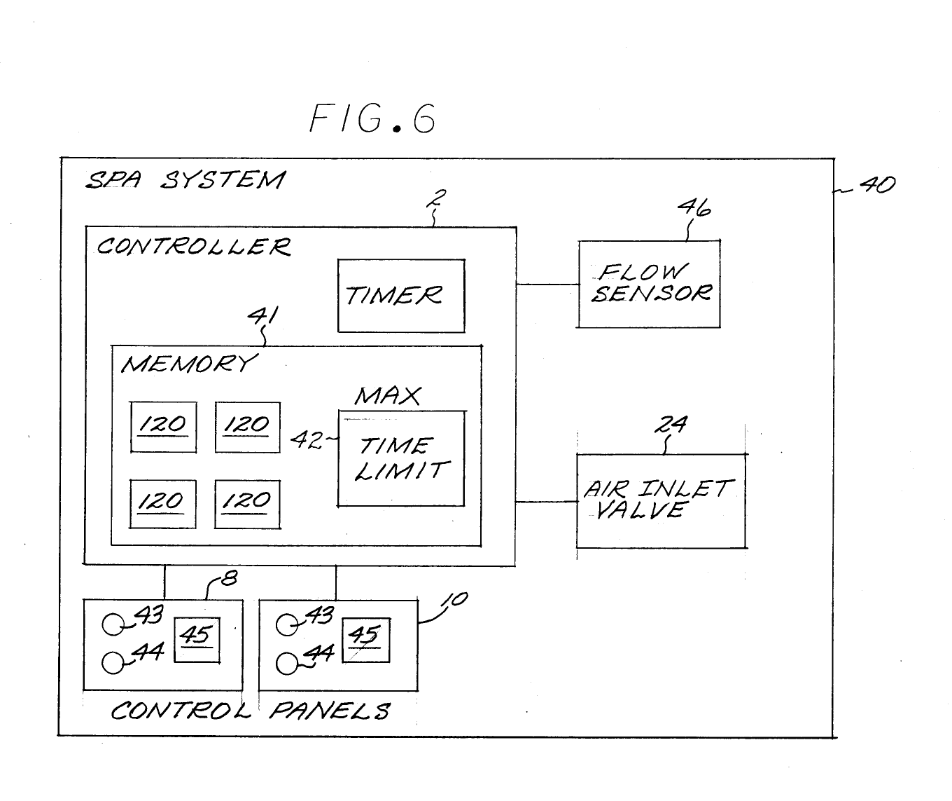

FIG. 6 illustrates an exemplary embodiment of a spa system 40 with a controller 2. The controller 2 may include an electronic controller and/or a microprocessor. The controller may have a memory 41. The memory 41 may be pre-programmed with operational sequences 120, for example, massage sequences. The memory 41 may also be pre-programmed with a maximum operational time limit 42. In an exemplary embodiment, the memory may include more than one maximum operational time limit 42 from which a user may select a desired maximum time limit.

The controller 2 may receive input data or signals from a variety of sources. For example, the controller 2 may receive a start signal, which prompts the controller 2 to start operation of the air inlet valve 24 according to an operational sequence 120. The start signal may be received from a user operated manual start switch 43 located at a control panel 8 or auxiliary control panel 10. The controller may also receive a manual stop signal, initiated by a manual stop switch 44 on a control panel 8, 10. A user may be able to select from among the various operational sequences 120 by inputting a selection at an operational sequence select switch 45, which may be located at a control panel 8, 10. The controller may also receive input from a flow sensor 46. The controller may shut the air inlet valve 24 or stop an operational sequence 120 upon receipt of a signal indicative of a no flow or low flow condition.

It is understood that the above-described embodiments merely illustrate the possible specific embodiments which may represent principles of the present invention. Other arrangements may readily be devised in accordance with these principles by those skilled in the art without departing from the scope and spirit of the invention.

What is claimed is:

1. A spa system comprising:
a water jet having a water flow path and an air injection port in communication with the water flow path;
an air system fluidically connected to the air injection port, wherein the air system comprises an air manifold comprising an air inlet port and a plurality of air outlet ports, the air system further comprising an air inlet valve coupled to the air inlet port; and
an electronic controller arranged to control actuation of the air inlet valve.

2. The spa system according to claim 1, wherein the air inlet valve comprises a solenoid operated valve and a valve plate.

3. The spa system according to claim 1, further comprising a check valve arranged within the air inlet port.

4. The spa system according to claim 1, wherein a first air outlet port provides air to a first water jet and a second air outlet port provides air to a second water jet.

5. The spa system according to claim 1, wherein the air manifold is located above a water level of the spa system.

6. The spa system according to claim 1, wherein the air inlet port is located above a water level of the spa system.

7. The spa system according to claim 1, wherein the controller is programmed with a plurality of air valve operational sequences.

8. The spa system according to claim 7, further comprising an operational sequence select switch for selecting one of the plurality of air valve operational sequences and a start switch for starting operation of the air inlet valve in accordance with the one of the plurality of air valve operational sequences, wherein the controller is programmed to shut the air inlet valve after a maximum operational time limit.

9. The spa system according to claim 1, further comprising a water flow sensor, wherein the controller is programmed to shut the air inlet valve responsive to a low flow signal or no flow signal from the water flow sensor.

10. The spa system according to claim 1, wherein the electronic controller is adapted to shut the air inlet valve after a predetermined operational period of time has elapsed.

11. A spa system comprising:
a vessel for holding water;
a pump for creating a water stream to be jetted into the vessel;
a water jet with a water flow path and an air injection port, wherein the water jet is arranged such that the water stream flows through the water flow path, to create a region of low pressure and the air injection port communicates with the water flow path at the region of low pressure;
an air supply system fluidically connected to the air injection port, wherein the air supply system includes an air manifold comprising an air inlet port, an air inlet valve for opening and closing the inlet port, an air outlet port, wherein the air outlet port is fluidically connected to the air injection port, and a check valve arranged at the air inlet port; and
an electronic controller arranged to control operation of the air inlet valve;
wherein the water jet is arranged such that air drawn into the water jet through the air supply system creates air bubbles which are jetted into the vessel along with the water stream.

12. The spa system according to claim 11, wherein the electronic controller is programmed with a plurality of operational sequences.

13. The spa system according to claim 11, wherein the electronic controller is programmed to shut the air inlet valve after a pre-set time limit.

14. A spa system comprising:
an air manifold for providing a source of air for a plurality of water jets, wherein the air manifold has an air inlet port and a plurality of air outlet ports each coupled to a respective one of the plurality of water jets;
an air inlet valve for opening and closing the air inlet port;
a means for controlling operation of the air inlet valve;
a means for storing a plurality of air inlet valve operational sequences;
a means for selecting an operational sequence from among the plurality of air inlet valve operational sequences;
wherein the means for controlling controls the air inlet valve to open and shut according to the selected operational sequence.

15. The spa system according to claim 14, wherein the means for controlling comprises a microprocessor.

16. The spa system according to claim 14, wherein the means for storing comprises a computer memory.

17. The spa system according to claim 14, wherein the means for selecting comprises a manual switch on a control panel.

18. The spa system according to claim 14, wherein the means for controlling the air inlet valve is programmed to stop the selected operational sequence after a pre-set time limit has expired.

19. The spa system according to claim 14, further comprising a check valve arranged within the air manifold.

20. A method of manufacturing a spa control system, comprising:
providing an electronic controller;
programming the electronic controller to actuate an air inlet valve to selectively allow air to be drawn into a water jet through an air injection port;
programming the controller to start operation of the air inlet valve in response to a start signal and to stop operation of the air inlet valve after a pre-set time period.

21. The method according to claim 20, further comprising programming the electronic controller to operate the air inlet valve in accordance with at least one of a plurality of operational sequences.

22. A method of operating a spa system, comprising:
providing a stream of water to be jetted into a vessel through a water jet, wherein the water jet has an air injection port;
initiating operation of an air inlet valve in an air manifold, wherein the air inlet valve is fluidically connected to an air inlet port of the water jet through a check valve located in the air manifold;
operating the air inlet valve in accordance with an operational sequence;
controlling the air inlet valve with an electronic controller.

23. The method according to claim 22, wherein initiating operation of an air inlet valve comprises operating a start switch at a control panel.

24. The method according to claim 22, wherein initiating operation of an air inlet valve comprises selecting the operational sequence from among a plurality of operational sequences.

25. The method according to claim 22, further comprising stopping operation of the air inlet valve after a pre-set maximum time limit.
